(19) United States
(12) Patent Application Publication
(10) Pub. No.: US 2009/0170742 A1
(43) Pub. Date: Jul. 2, 2009

(54) AQUEOUS CLEANING COMPOSITION

(75) Inventors: Tsung-Hsien Chuang, Kaohsiung (TW); Chien-Ching Chen, Kaohsiung (TW); Wen-Cheng Liu, Kaohsiung (TW)

Correspondence Address: SHERIDAN ROSS PC, 1560 BROADWAY, SUITE 1200, DENVER, CO, 80202, US

(73) Assignee: EPOCH MATERIAL CO., LTD., Kaohsiung County (TW)

(21) Appl. No.: 12/194,078

(22) Filed: Aug. 19, 2008

(30) Foreign Application Priority Data
Dec. 28, 2007 (TW) 096150807

(51) Int. Cl. C11D 7/32

(52) U.S. Cl. 510/175

(57) ABSTRACT

An aqueous cleaning composition for cleaning wafer contaminants after a chemical mechanical planarization process, includes: 0.1-20 wt % of an alkanolamine selected from the group consisting of 2-amino-1,3-propanediol, 2-amino-2-(hydroxymethyl)-1,3-propanediol, and combinations thereof; 0.05-20 wt % of a quaternary amine; and water. The cleaning composition is capable of removing efficiently residual contaminants from a polished surface of a wafer and imparting the wafer with a better surface roughness.

### BACKGROUND OF THE INVENTION

1. Field of the Invention

This invention relates to an aqueous cleaning composition, more particularly to an aqueous cleaning composition including an alkanolamine for removing residues formed after Chemical Mechanical Planarization (CMP) of a wafer for integrated circuit processing.

2. Description of the Related Art

The current trend of developing semiconductor devices is toward a smaller line width and a higher integrated circuit (IC) density. When the line width is less than 0.25 μm, an undesired time delay (RC delay) attributed to metal resistance and parasitic capacitor effect occurs, which, in turn, results in reduced device speed. Therefore, a high-level process has been developed, which uses copper interconnect for replacement of conventional aluminum-copper alloy wires, so as to increase the device speed.

Chemical Mechanical Planarization (CMP) has been applied in the copper interconnect process, can overcome the patterning problem resulting from the difficulty in copper metal etching, and can achieve global planarization so as to facilitate multilayer interconnect process. The CMP process involves the use of a slurry having chemical reagents and abrasive particles for polishing a wafer surface. However, contaminants, such as slurry residue and abraded particles thus formed, tend to be attached to and are difficult to be removed from the wafer surface after polishing, and can result in low production yield and poor reliability for the semiconductor devices. As such, the cleaning process after CMP is very important to the success of application of CMP to IC processing or semiconductor processing.

In the copper interconnect process, the slurry usually includes benzotriazole (BTA) or derivatives thereof, which serves as a corrosion inhibitor and which is very difficult to be removed during cleaning due to its strong bonding with the copper interconnect. Conventional removal of BTA involves physical removal techniques, such as static electricity repulsion force, ultrasonic vibration and scrubbing with a brush made from polyvinyl alcohol (PVA). However, the aforesaid removal techniques have a poor cleaning effect.

After the CMP process, inter-metal dielectric layers and tungsten (W) plugs are cleaned using ammonia, citric acid and/or fluorine-containing compounds. However, the aforesaid cleaning solutions are not suitable for the copper interconnect. Ammonia can result in non-uniform corrosion of the copper surface, thereby resulting in a roughened copper surface, which has an adverse effect on device performance. Citric acid solution has a poor dissolving ability in copper and a poor removing rate of contaminants. The fluorine-containing compounds, such as hydrogen fluoride, can cause excessive corrosion of copper and have safety and environmental concerns.

U.S. Pat. No. 6,498,131 discloses a composition for removing CMP residue, including an aqueous solution having a pH value ranging from 10 to 12.5. The aqueous solution includes at least one non-ionic surfactant, at least one amine, at least one quaternary amine, and at least one sticking agent selected from the group consisting of ethyl alcohol, propylene alcohol, polyethylene oxide, polypropylene oxide, and combinations thereof. The amine employed in the composition is monoethanolamine (MEA). However, the MEA results in excessive corrosion of copper and higher roughened copper surface.

U.S. Pat. No. 6,492,308 discloses a cleaning solution for cleaning a copper-containing integrated circuit, including a C₁-C₁₀ quaternary ammonium hydroxide, a polar organic amine, and a corrosion inhibitor. The organic amine employed in the composition is monoethanolamine.

U.S. Pat. No. 5,988,186 discloses an aqueous cleaning composition for removing organic or inorganic matter, including a mixture of a water-soluble polar solvent, an organic amine and a corrosion inhibitor having alcohol and ester functional groups. The organic amine employed in the composition includes tetramethylammonium hydroxide.

U.S. Patent Application Publication No. 2007/0066508 discloses an aqueous cleaning composition for wafers with copper interconnect in post chemical mechanical planarization of an integrated circuit processing, including a nitrogen-containing heterocyclic organic base, an alcohol amine, and water.

U.S. Patent Application Publication No. 2006/0229221 discloses a cleaning composition for cleaning microelectronic substrates, including a quaternary ammonium hydroxide, an alkanolamine, and water. The quaternary ammonium hydroxide is selected from the group consisting of tetramethylammonium hydroxide, tetrabutylammonium hydroxide, and combinations thereof. The alkanolamine employed in the composition is selected from the group consisting of monoethanolamine, 1-amino-2-propanol, 2-(methylamino)ethanol, triethanolamine, and combinations thereof.

Development of the semiconductor technology has reached a new era in which the line width is reduced to 32 nm. However, problems, such as undesired roughness of the surface of the wafers and poor reliability in electrical property of the copper interconnect, occur. Therefore, there is a need for a cleaning composition that can effectively remove contaminants and reduce defects on the wafer surface while maintaining the better copper surface roughness.

### SUMMARY OF THE INVENTION

Therefore, an object of the present invention is to provide an aqueous cleaning composition that can efficiently remove residuals from copper interconnects on a wafer after CMP processing and reduce the numbers of surface defects of the wafer while maintain the better surface roughness of the wafer.

According to the present invention, an aqueous cleaning composition comprises: 0.1-20 wt % of an alkanolamine selected from the group consisting of 2-amino-2-(hydroxymethyl)-1,3-propanediol, 2-amino-1,3-propanediol, and combinations thereof; 0.05-20 wt % of a quaternary amine; and water.

### DETAILED DESCRIPTION OF THE PREFERRED EMBODIMENT

The aqueous cleaning composition according to this invention includes: 0.1-20 wt % of an alkanolamine selected from the group consisting of 2-amino-2-(hydroxymethyl)-1,3-propanediol, 2-amino-1,3-propanediol, and combinations thereof; 0.05-20 wt % of a quaternary amine; and water.

In this embodiment, the alkanolamine is 2-amino-2-(hydroxymethyl)-1,3-propanediol.

Preferably, the quaternary amine is tetraalkylammonium hydroxide selected from the group consisting of tetramethylammonium hydroxide, tetraethylammonium hydroxide, tetrapropylammonium hydroxide, and combinations thereof.

In this embodiment, the quaternary amine is tetramethylammonium hydroxide.

It is noted that a high concentration of the aqueous cleaning composition is initially provided for saving on production, transportation and storage costs, and is diluted about 1 to 60-fold with ultra purified water when in use. Alternatively, the high concentration of the aqueous cleaning composition can be used to clean wafers in special circumstances, such as saving processing time.

The aqueous cleaning composition can be used under room temperature condition. Contaminants on the copper-containing wafers can be efficiently removed and the surface roughness of the copper interconnect can be maintained after contacting with the aqueous cleaning composition for a period of time. In general, the higher the concentration of the aqueous cleaning composition, the less will be the time. In practical use, the user can use different concentrations of the aqueous cleaning composition with corresponding contacting times according to actual requirements for achieving process optimization.

Preferably, the alkanolamine is in an amount ranging from 0.1 to 15 wt %, more preferably, from 0.1 to 10 wt %.

Preferably, the quaternary amine is in an amount ranging from 0.05 to 15 wt %, more preferably, from 0.05 to 10 wt %.

Preferably, the aqueous cleaning composition further comprises a nitrogen-containing heterocyclic organic base.

In this embodiment, the nitrogen-containing heterocyclic organic base is a piperazine.

The aqueous cleaning composition can be used in a CMP apparatus for cleaning the polished wafer surface. In addition, it can be used in a separate cleaning apparatus for cleaning the wafer.

The merits of the aqueous cleaning composition of this invention will become apparent with reference to the following Examples and Comparative Examples.

### Testing Method

Copper solubility test: a blanket copper wafer was cut into a 1.5 cm×1.5 cm specimen, which was then subjected to an acid dissolving treatment so as to remove copper oxide on a surface of the copper specimen. The copper specimen was then immersed in a 50 ml solution including the aqueous cleaning composition for 1 min, followed by analysis of the copper concentration in the solution using an Inductively Coupled Plasma Mass Spectrometry (ICP-MS).

Benzotriazole (BTA) saturated solubility test: a solution including the aqueous cleaning composition and an excess amount of BTA solids were mixed under a temperature of 25° C. After stirring for 4 hr, the mixture was filtered so as to remove insoluble matters, followed by analysis of BAT concentration in the solution using High Performance Liquid Chromatography (HPLC).

Surface roughness measurement (average roughness (Ra) and root mean square roughness (Rq)): a polished blanket copper wafer was cleaned using the solution including the aqueous cleaning composition for 2 min, followed by analysis of the surface roughness of the blanket copper wafer using Atomic Force Microscope (AFM).

Contaminant removal rate measurement: a blanket copper wafer was immersed in a polishing slurry having a corrosion inhibitor (BTA) therein for 1 min so as to obtain a contaminated blanket copper wafer, and then was dried using spin drying techniques after rinsing with ultra purified water for 18 sec. The number (A) of particles on the contaminated blanket copper wafer before cleaning was measured using a particle measurement instrument (TOPCON WN-1700). The contaminated blanket copper wafer was then cleaned using the different cleaning compositions for 2 min, and finally was dried using spin drying techniques after rinsing with ultra purified water for 18 sec. The number (B) of particles on the blanket copper wafer after cleaning was measured using the particle measurement instrument (TOPCON WN-1700). The removal rate was calculated based on the following equation:

Contaminant Removal Rate=(((A−B)/A)×100%).

### EXAMPLES

### Examples 1-5 (E1-5) and Comparative Examples 1-3 (CE1-3)

Table 1 shows the content of each of the components of the aqueous cleaning composition of Examples 1-5 and Comparative Examples 1-3.

The aqueous cleaning composition of Comparative Example 1 includes diethanolamine (DEA), triethanolamine (TEA) and piperazine.

The aqueous cleaning composition of Comparative Example 2 is citric acid solution.

The aqueous cleaning composition of Comparative Example 3 is ultra purified water.

Note that the original concentration of each of the aqueous cleaning composition of Examples 1-5 and Comparative Examples 1-3 was a concentrated solution, which was diluted to 30-fold for testing according to the actual requirements.

TABLE 1

| | Original composition | | | Diluted 30-fold | | |
|---|---|---|---|---|---|---|
| | 2-amino-2- | Tetramethyl- | | 2-amino-2- | Tetramethyl- | |
| | (hydroxymethyl)- | ammonium | | (hydroxymethyl)- | ammonium | |
| | 1,3-propanediol | hydroxide | Piperazine | 1,3-propanediol | hydroxide | Piperazine |
| | (wt %) | (wt %) | (wt %) | (wt %) | (wt %) | (wt %) |
| E1 | 5.0 | 2.5 | — | 0.16 | 0.08 | — |
| E2 | 5.0 | 10.0 | — | 0.16 | 0.33 | — |
| E3 | 10.0 | 2.5 | — | 0.33 | 0.08 | — |
| E4 | 10.0 | 10.0 | — | 0.33 | 0.33 | — |
| E5 | 10.0 | 10.0 | 7.0 | 0.33 | 0.33 | 0.23 |

| | | |
|---|---|---|
| CE1 | DEA10.0 wt %, TEA 10.0 wt % and | DEA 0.33 wt %, TEA 0.33 wt % and |
| | Piperazine 9 wt % | Piperazine 0.3 wt % |
| CE2 | Citric acid solution 30 wt % | Citric acid solution 1 wt % |
| CE3 | Ultra purified water | Ultra purified water |

“—” means not added.

The testing and measuring results are shown in Table 2.

TABLE 2

| | | | BTA | Surface | | Contaminant |
|---|---|---|---|---|---|---|
| | | Copper | Saturated | rough- | Surface | Removal |
| | pH | solubility | solubility | ness | roughness | Rate |
| | value | (ppb) | (%) | Ra(nm) | Rq(nm) | (%) |
| E1 | 11.88 | 24.8 | 2.17 | 0.784 | 1.032 | 93.24 |
| E2 | 12.40 | 27.17 | 2.60 | 0.829 | 1.064 | 96.32 |
| E3 | 11.89 | 37.67 | 2.29 | 0.803 | 1.123 | 93.63 |
| E4 | 12.41 | 29.90 | 2.83 | 0.862 | 1.121 | 95.46 |
| E5 | 12.44 | 30.60 | 3.33 | 0.734 | 0.999 | 94.49 |
| CE1 | 11.01 | 23.07 | 3.25 | 0.987 | 1.150 | 82.39 |
| CE2 | 3.89 | <2 | — | 0.872 | 1.087 | 88.18 |
| CE3 | 7.73 | <2 | — | 0.718 | 1.101 | 0 |

“—” means no reaction

The results show that copper can be dissolved in the solution having the 2-amino-2-(hydroxymethyl)-1,3-propanediol therein, and addition of the piperazine (Example 5) improves the BTA saturated solubility. The citric acid solution and water have no ability to dissolve the copper (Comparative Examples 2 and 3). The aqueous cleaning composition having stronger copper solubility and BAT saturated solubility shows a better clean of contaminants and BTA. However, improper copper solubility (fast or non-uniform) can have an adverse effect on the surface roughness of the polished wafer. The surface roughness (Ra and Rq) of Examples 1-5 are similar to those of Comparative Examples 1-3, which indicates that the aqueous cleaning composition of Examples 1-5 can dissolve the copper, while maintaining the better surface roughness.

In addition, the aqueous cleaning composition of Examples 1-5 improves the contaminant removal rate as compared to those of Comparative Examples 1-3.

With the invention thus explained, it is apparent that various modifications and variations can be made without departing from the spirit of the present invention. It is therefore intended that the invention be limited only as recited in the appended claims.

What is claimed is:

1. An aqueous cleaning composition comprising:
0.1-20 wt % of an alkanolamine selected from the group consisting of 2-amino-1,3-propanediol, 2-amino-2-(hydroxymethyl)-1,3-propanediol, and combinations thereof;
0.05-20 wt % of a quaternary amine; and
water.

2. The aqueous cleaning composition of claim 1, wherein said alkanolamine is 2-amino-2-(hydroxymethyl)-1,3-propanediol.

3. The aqueous cleaning composition of claim 1, wherein said quaternary amine is tetraalkylammonium hydroxide.

4. The aqueous cleaning composition of claim 3, wherein said tetraalkylammonium hydroxide is selected from the group consisting of tetramethylammonium hydroxide, tetraethylammonium hydroxide, tetrapropylammonium hydroxide, and combinations thereof.

5. The aqueous cleaning composition of claim 4, wherein said tetraalkylammonium hydroxide is tetramethylammonium hydroxide.

6. The aqueous cleaning composition of claim 1, wherein said alkanolamine is in an amount ranging from 0.1 to 15 wt %.

7. The aqueous cleaning composition of claim 6, wherein said alkanolamine is in an amount ranging from 0.1 to 10 wt %.

8. The aqueous cleaning composition of claim 1, wherein said quaternary amine is in an amount ranging from 0.05 to 15 wt %.

9. The aqueous cleaning composition of claim 8, wherein said quaternary amine is in an amount ranging from 0.05 to 10 wt %.

10. The aqueous cleaning composition of claim 1, further comprising a nitrogen-containing heterocyclic organic base.

11. The aqueous cleaning composition of claim 10, wherein said nitrogen-containing heterocyclic organic base is a piperazine.
